(19) United States
(12) Patent Application Publication
(10) Pub. No.: US 2007/0254667 A1
(43) Pub. Date: Nov. 1, 2007

(54) Inter-MME handover in evolved communication systems

(76) Inventor: Joanna Jokinen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/785,717

(22) Filed: Apr. 19, 2007

Related U.S. Application Data
(60) Provisional application No. 60/795,581, filed on Apr. 28, 2006.

(51) Int. Cl. H04Q 7/20

(52) U.S. Cl. 455/436

(57) ABSTRACT

Measures for a handover in a communication system, the communication system comprising an access network having at least two base station entities and a core network having at least two control plane entities and at least one user plane entity, comprising the steps of initiating, upon completion of a radio network handover between a source base station entity and a target base station entity, a core network handover by the target base station entity, and performing the core network handover between a source control plane entity and a target control plane entity, wherein the user plane entity is maintained the same or changed.

### CROSS-REFERENCE TO RELATED APPLICATION

This application claims priority of U.S. Provisional Patent Application Ser. No. 60/795,581, filed on Apr. 28, 2006. The subject matter of this earlier filed application is hereby incorporated by reference.

### FIELD OF THE INVENTION

The present invention relates to an inter-MME handover in evolved communication systems. In particular, the present invention relates to handover procedures in communication systems of advanced system architecture evolution.

### BACKGROUND OF THE INVENTION

Recently, standardization work in the field of communication systems is also directed to future system architecture. In the Third Generation Partnership Project (3GPP) respective efforts are referred to as system architecture evolution (SAE) and/or long term evolution (LTE).

In principle, SAE/LTE communication systems currently under discussion comprise an access network part such as e.g. UTRAN (Universal Terrestrial Radio Access Network) and a core network part. In the access network, base station entities such as base transceiver stations (BTS) or Node_B's serve as access nodes for user equipment terminals. In the core network, functional entities have been defined: a user plane entity (UPE) is defined for the user plane and a control plane entity such as a mobility management entity (MME) is defined for the control plane. These functional entities (MME and UPE) might be integrated into one element, or separated with an open interface defined in between. Generally, MME and UPE together are seen from radio network point of view as an Access Gateway (AGW). The term AGW can refer to an integrated MME+UPE node, but the term can also be used at the current, early phase of standardization to refer generally to MME and UPE, even if those would actually be defined as separate nodes.

Core network control nodes are logically organized in so-called pool areas, wherein one or more access network entities are related to one or more pool areas so as to form a many-to-may relation between access network entities and core network entities.

One important issue in the standardization of SAE/LTE systems are handover procedures. There have been proposed several procedures for different kinds of handovers which are conceivable.

In the document “R3-060424” presented at the 3GPP TSG-RAN WG3 meeting #51bis on 3 to 5 Apr. 2006, an AGW relocation in an active mode has been proposed. Taking into account the above, an AGW relocation effects a combined user plane (UPE) relocation and control plane (MME) relocation. The thus proposed AGW relocation is done for route optimization purposes, i.e. user plane aspects, and is initiated by the core network part of the communication system. Namely, when the routing between an AGW and a serving Node_B becomes inefficient, the access gateway is relocated while maintaining the same serving base station entity, i.e. the same Node_B. Stated in other words, a core network handover is performed without performing an access network handover. This is however a disadvantage of this proposal in that active user equipments running out of coverage from the serving Node_B will have to go into an idle mode and reconnect to a new Node_B again afterwards.

In the document “R3-060439” presented at the 3GPP TSG-RAN WG3 meeting #51bis on 3 to 5 Apr. 2006, another solution for a relocation of AGW for active user equipments is set out. Although the necessity of AGW relocations in active mode is generally denied in this document, the thus proposed procedure represents an inter-AGW handover, i.e. a core network handover, in connection with an access network handover between two Node_B's. The solution is based on known intra-AGW handover procedures being supplemented by a necessary user context transfer from an old AGW to a new AGW, as well as extending path switching to also include the UPE part. In this solution the core network is involved in the handover signaling preparation. Namely, the user context is fetched into the new AGW during handover preparation. This is a disadvantage thereof in that it conflicts with existing 3GPP requirements.

It is common to both solutions described above that a relocation of an access gateway is performed, thus including a user plane relocation as well as a control plane relocation at the same time. Yet, a separation of user plane and control plane functions is supported by recent standardization work. It might thus be beneficial to enable a separated control plane relocation, i.e. an inter-MME handover. No solution to this problem has yet been shown in the art.

This problem is however of practical importance. For example when a new/target base station entity (e.g. a target Node_B), to which a user equipment has been handed over in an access network handover, can no longer serve the same MME pool are as the old/source base station entity, an inter-MME handover has to take place.

Another problem, which has not been addressed recently, is that a frequent transition between an active mode and an idle mode is expected and users are not expected to stay in active mode unless they really transfer data. Although it might be more likely that MME changes are performed in idle mode than in active mode, a solution for active mode inter-MME handovers is also needed, but has not been shown in the art.

Thus, a solution to the above problems and drawbacks is needed for providing inter-MME handovers in evolved communication systems.

### SUMMARY OF THE INVENTION

Consequently, it is an object of the present invention to remove the above drawbacks inherent to the prior art and to provide accordingly improved methods, network nodes, systems and computer programs.

According to a first aspect of the invention, this object is for example achieved by a method a method of handover in a communication system, the communication system comprising an access network having at least two base station entities and a core network having at least two control plane entities and at least one user plane entity, the method comprising

initiating, upon completion of a radio network handover between a source base station entity and a target base station entity, a core network handover by the target base station entity; and

performing the core network handover between a source control plane entity and a target control plane entity, wherein the user plane entity is maintained the same or changed.

According to a second aspect of the invention, this object is for example achieved by a method of operating a base station entity of a communication system, the communication system comprising an access network having at least two base station entities and a core network having at least two control plane entities and at least one user plane entity, the method comprising

detecting a completion of a radio network handover between a source base station entity and said base station entity acting as a target base station entity; and

initiating, upon detection of a radio network handover completion, a core network handover between a source control plane entity and a target control plane entity.

According to a third aspect of the invention, this object is for example achieved by a method of operating a control plane entity of a communication system, the communication system comprising an access network having at least two base station entities and a core network having at least two control plane entities and at least one user plane entity, the control plane entity acting as a target control plane entity of a core network handover, the method comprising

performing the core network handover between a source control plane entity and the target control plane entity, wherein the user plane entity is maintained the same or changed.

According to a fourth aspect of the invention, this object is for example achieved by a method of operating a control plane entity of a communication system, the communication system comprising an access network having at least two base station entities and a core network having at least two control plane entities and at least one user plane entity, the control plane entity acting as a source control plane entity of a core network handover, the method comprising

performing the core network handover between the source control plane entity and a target control plane entity, wherein the user plane entity is maintained the same or changed.

According to a fifth aspect of the invention, this object is for example achieved by a base station entity of a communication system, the communication system comprising an access network having at least two base station entities and a core network having at least two control plane entities and at least one user plane entity, the base station entity comprising:

detecting means for detecting a completion of a radio network handover between a source base station entity and said base station entity acting as a target base station entity; and

initiating means for initiating, upon detection of a radio network handover completion, a core network handover.

According to a sixth aspect of the invention, this object is for example achieved by control plane entity of a communication system, the communication system comprising an access network having at least two base station entities and a core network having at least two control plane entities and at least one user plane entity, the control plane entity being configured to perform a core network handover between said control plane entity and another control plane entity, wherein the user plane entity is maintained the same or changed.

According to a seventh aspect of the invention, this object is for example achieved by a system of a communication system, the communication system comprising an access network having at least two base station entities and a core network having at least two control plane entities and at least one user plane entity, the system comprising:

at least one base station entity according to any above option, which acts as a target base station entity of an access network handover; and

at least two control plane entities according to any above option, one of which acts as a source control plane entity of a control network handover and the other one acting as a target control plane entity of the control network handover.

According to an eighth aspect of the invention, this object is for example achieved by a computer program embodied in a computer-readable medium comprising program code configured to operate a base station entity of a communication system, the communication system comprising an access network having at least two base station entities and a core network having at least two control plane entities and at least one user plane entity, the computer program being configured to perform

detecting a completion of a radio network handover between a source base station entity and said base station entity acting as a target base station entity; and

initiating, upon detection of a radio network handover completion, a core network handover between a source control plane entity and a target control plane entity.

According to a ninth aspect of the invention, this object is for example achieved by a computer program embodied in a computer-readable medium comprising program code configured to operate a control plane entity of a communication system, the communication system comprising an access network having at least two base station entities and a core network having at least two control plane entities and at least one user plane entity, the control plane entity acting as a target control plane entity of a core network handover, the computer program being configured to perform performing the core network handover between a source control plane entity and the target control plane entity, wherein the user plane entity is maintained the same or changed.

According to a tenth aspect of the invention, this object is for example achieved by a computer program embodied in a computer-readable medium comprising program code configured to operate a control plane entity of a communication system, the communication system comprising an access network having at least two base station entities and a core network having at least two control plane entities and at least one user plane entity, the control plane entity acting as a source control plane entity of a core network handover, the computer program being configured to perform the step of:

performing the core network handover between the source control plane entity and a target control plane entity, wherein the user plane entity is maintained the same or changed.

It is an advantage of the present invention that a concept for handovers between control plane entities, independently of the user plane entity (i.e., either maintaining or also changing the user plane entity) is provided.

With the embodiments of the present invention, it is advantageous that active mode handovers are feasible between control plane entities.

Further, it is advantageous that the thus presented handover procedures are controlled by access network nodes, i.e. that the access network has control over the handover.

Further, it is advantageous that the core network is not involved in the handover preparation phase.

Further, it is advantageous that a lossless delivery is achieved by using a forwarding from one base station entity to the next base station entity, and that the user plane is switched only after a handover has been completed, i.e. late switching.

From an implementation point of view, it is beneficial that the embodiments of the present invention comply with existing standards and specifications.

### BRIEF DESCRIPTION OF THE DRAWINGS

In the following, the present invention will be described in greater detail with reference to the accompanying drawings, in which

FIG. 1 shows a signaling diagram of a method according to a first embodiment of the present invention;

FIG. 2 shows a signaling diagram of a method according to a second embodiment of the present invention;

FIG. 3 shows a signaling diagram of a method according to a third embodiment of the present invention;

FIG. 4 shows a schematic block diagram of a system according to a fourth embodiment of the present invention;

FIG. 5 shows a schematic block diagram of a system according to a fifth embodiment of the present invention; and

FIG. 6 shows a schematic block diagram of a system according to a sixth embodiment of the present invention.

### DETAILED DESCRIPTION OF EMBODIMENTS OF THE PRESENT INVENTION

The present invention is described herein with reference to particular non-limiting examples. A person skilled in the art will appreciate that the invention is not limited to these examples, and may be more broadly applied.

In particular, the present invention is described in relation to SAE/LTE terminology according to 3GPP standardization. As such, the description of the embodiments given herein specifically refers to terminology which is directly related to SAE/LTE. Such terminology is only used in the context of the presented examples, and does not limit the invention in any way. Rather, the present invention is applicable to any suitable communication system having network nodes and an architecture, which are similar to those of the underlying example.

Furthermore, the description of the embodiments of the present invention with reference to the accompanying drawings focuses on those parts of the drawings which are representative of and/or essential for the present invention. The description of parts which are known to a skilled person will be omitted for the sake of clarity.

In the following, a base station entity of an access network is exemplified by way of a so-called eNodeB, (which is intended to represent a Node_B of an evolved system), a control plane entity (e.g. a mobility management entity MME) is exemplified by way of a so-called eGSN-C (which is intended to represent an evolved GPRS support node of the control plane), and a user plane entity is exemplified by way of a so-called eGSN-U (which is intended to represent an evolved GPRS support node of the user plane).

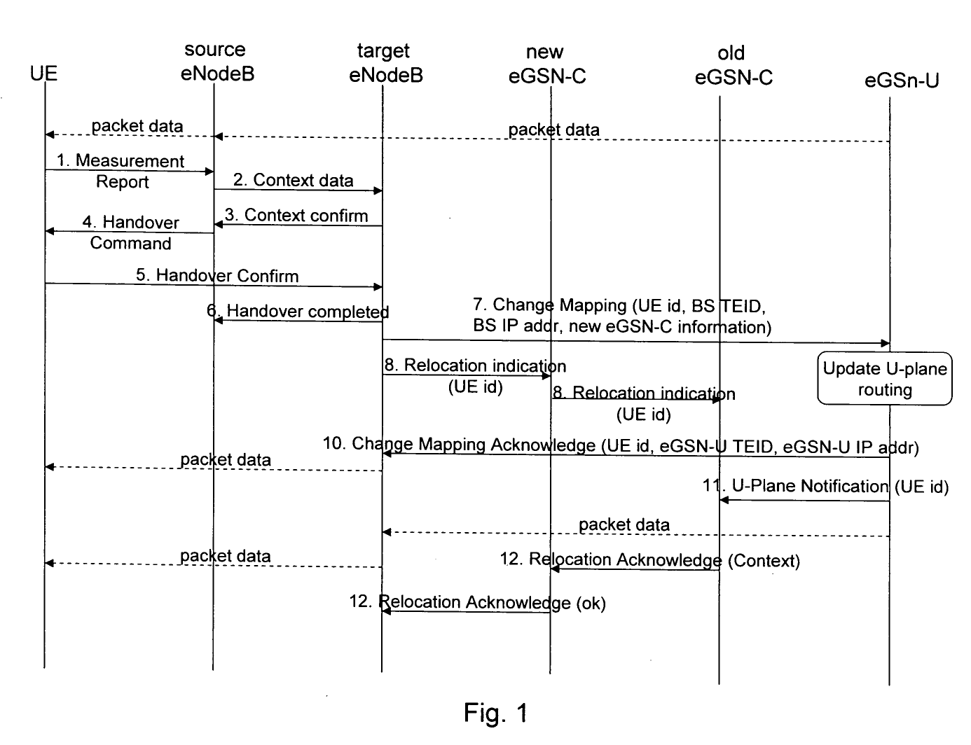

FIG. 1 shows a signaling diagram of a method according to a first embodiment of the present invention. In detail, there is illustrated an inter-MME handover procedure, wherein the core network is not involved in handover preparation, wherein late switching and base station forwarding is used, and wherein path switching is effected directly from a target base station entity to a user plane entity.

In FIG. 1, steps 1 to 6 represent an access network handover between a source base station or eNodeB and a target base station or eNodeB. Such an intra-access system handover is as such known to a skilled person and will thus not be discussed in detail hereinafter.

The access network handover is completed by a respective message in step 6, which is sent from the target base station to the source base station. Upon this completion, the target base station of the access network decides on the need for a core network handover, i.e. an inter-MME handover. Such a decision is for example based on an interrelation of the target base station and the source control plane entity, i.e. the eGSN-C which currently serves the user equipment. That is, a decision is based on control plane issues, for example in particular to the fact that the source control plane entity is not configured to be contacted by the new base station after a radio network handover. An example for such an interrelation is the organization of pool areas. That is, a core network handover is for example decided to be necessary by the target base station, when the new (target) base station is not configured to serve and connect the same MME pool area as the old (source) base station, as already mentioned above.

If necessary, the target base station initiates a core network handover between the current (old/source) eGSN-C and a new (target) eGSN-C. The target eGSN-C is selected by the target base station for example in a similar way as during an initial IMSI (IMSI=international mobile subscriber identity) attach procedure, when there is no knowledge of the UE in the network previously, or also similarly as on P-TMSI (Packet Temporary Mobile Subscriber Identity) attach procedure when the old eGSN-C cannot be connected by the serving base station. So, a normal way of selecting a new eGSN-C would be based on information on a previously selected node (which could be either a standardized or an implementation specific way).

The core network handover according to the present embodiment is based on a direct path switching from the target base station to the user plane entity eGSN-U, and is performed as follows.

In step 7 of FIG. 1, the target base station eNodeB instructs a user plane mapping change in order to change a user data path from the source eNodeB to the target eNodeB. To this end, the target eNodeB sends a change mapping message to the user plane entity eGSN-U, which includes as parameters an user equipment identity “UE id”, a new base station tunnel endpoint identifier “BS TEID”, an Internet Protocol (IP) address of the target base station “BS IP addr”, and information of the selected new eGSN-C. The address of the eGSN-U is known to the sending target eNodeB because of having received it from the source eNodeB with context information in step 2 above.

Upon receipt of the change mapping message from the target eNodeB, the user plane entity changes the user plane mapping, i.e. updates user plane routing, towards the target base station. Thereafter, it sends a message, denoted by “change mapping acknowledge” in FIG. 1, back to the target base station, providing the user equipment identity “UE id”, its own tunnel endpoint identifier “eGSN-U TEID” and its own IP address information “eGSN-U IP addr” (step 10). After that, it also sends a notification towards the old eGSN-C (i.e. the eGSN-C which selected the eGSN-U when the present IP context has been established), by which notification the old control plane entity is notified of the user plane mapping change effected at the eGSN-U (step 11). The notification message includes the permanent user equipment identity “UE id”. Upon sending of this notification, the user plane entity replaces old eGSN-C address information with new eGSN-C address information to indicate that the control of the IP context has been moved to the new eGSN-C, i.e. to the target control plane entity.

At the same time as step 7, the target eNodeB also sends a relocation indication message towards the new (target) eGSN-C (step 8) to indicate to the new control node that control is going to be moved to that eGSN-C. The message includes at least the permanent user equipment identity “UE id”. The message may for example additionally contain an old temporary identity with an old signature and an old tracking area information (in order to enable the new eGSN-C to find the old eGSN-C). Alternatively, but not shown in FIG. 1, the target base station could also directly provide the IP address of the old eGSN-C, as this could have been transferred to the target eNodeB from the source eNodeB beforehand.

After receiving the relocation indication from the target eNodeB, the new eGSN-C contacts the old eGSN-C by forwarding the relocation indication in order to receive user information therefrom (step 9). This message again at least the permanent user equipment identity “UE id”.

After having received the indication message of step 9 and the notification message of step 11, which is understood by the old eGSN-C such that the control is now switched to the new eGSN-C, the old eGSN-C sends a relocation acknowledge message to the new eGSN-C (step 12). Thereby, context data of the user equipment are supplied to the new control plane entity. The context data will be kept stored at the old eGSN-C after supplying them to the new eGSN-C for a while until it is deleted.

Finally, in step 13, the new eGSN-C acknowledges the relocation to the target eNodeB, thus completing the core network handover.

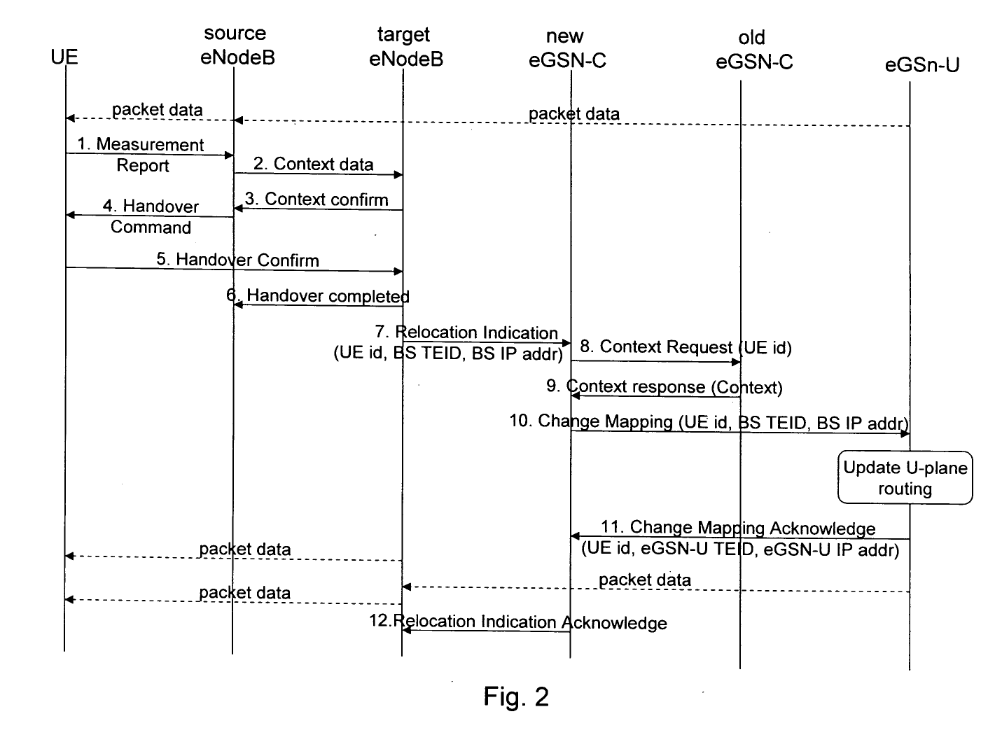

FIG. 2 shows a signaling diagram of a method according to a second embodiment of the present invention. In detail, there is illustrated an inter-MME handover procedure, wherein the core network is not involved in handover preparation, wherein late switching and base station forwarding is used, and wherein path switching is effected from the target base station entity via the target control plane entity to the user plane entity.

As well as in FIG. 1, steps 1 to 6 of FIG. 2 represent an access network handover between a source base station or eNodeB and a target base station or eNodeB, the description of which will be omitted herein.

The completion of the access network handover, the decision on the need of a core network handover, the selection of a target control plane entity and the initiation of the core network handover by the target base station is similar to those as described in connection with the embodiment of FIG. 1.

The core network handover according to the present embodiment is based on a path switching from the target base station entity via the target control plane entity to the user plane entity, and is performed as follows.

In step 7 of FIG. 2, the target eNodeB sends a relocation indication message towards the new eGSN-C, instructing the new eGSN-C to initiate switch mapping of the user plane towards the eGSN-U. The message at least contains the user equipment identity “UE id” and mapping information for the user plane of the base station side (i.e. tunnel endpoint identifier “BS TEID” and IP address “BS IP addr”). The message may for example additionally contain an old temporary identity with an old signature and an old tracking area information (in order to enable the new eGSN-C to find the old eGSN-C). Alternatively, but not shown in FIG. 2, the target base station could also directly provide the IP address of the old eGSN-C, as this could have been transferred to the target eNodeB from the source eNodeB beforehand.

The new (target) eGSN-C then finds the old (source) eGSN-C address either directly from the received message or based on the old tracking area. Then, the new eGSN-C sends to the old eGSN-C a message requesting user context data corresponding to the included user equipment identity “UE id” (step 8). The old eGSN-C supplies the user context data as a response (step 9), and after that considers the new eGSN-C to be in control of this user. The context data of the user is still left in the old eGSN-C for a while until it will be deleted.

After being supplied with the user context data including the eGSN-U address, the new eGSN-C considers itself being in control of this user equipment, and updates user plane information in the eGSN-U to point towards the target base station. This is done by sending a change mapping message to the user plane entity in step 10, which includes as parameters “UE id”, “BS TEID” and “BS IP addr”. Thereupon, the eGSN-U effects the user plane mapping change in the form of updating the user plane routing, and in step 11 acknowledges the change mapping message towards the new (target) eGSN-C with the same parameters as above in the first embodiment.

Finally, in step 12, the new eGSN-C acknowledges the relocation indication to the target eNodeB, thus completing the core network handover.

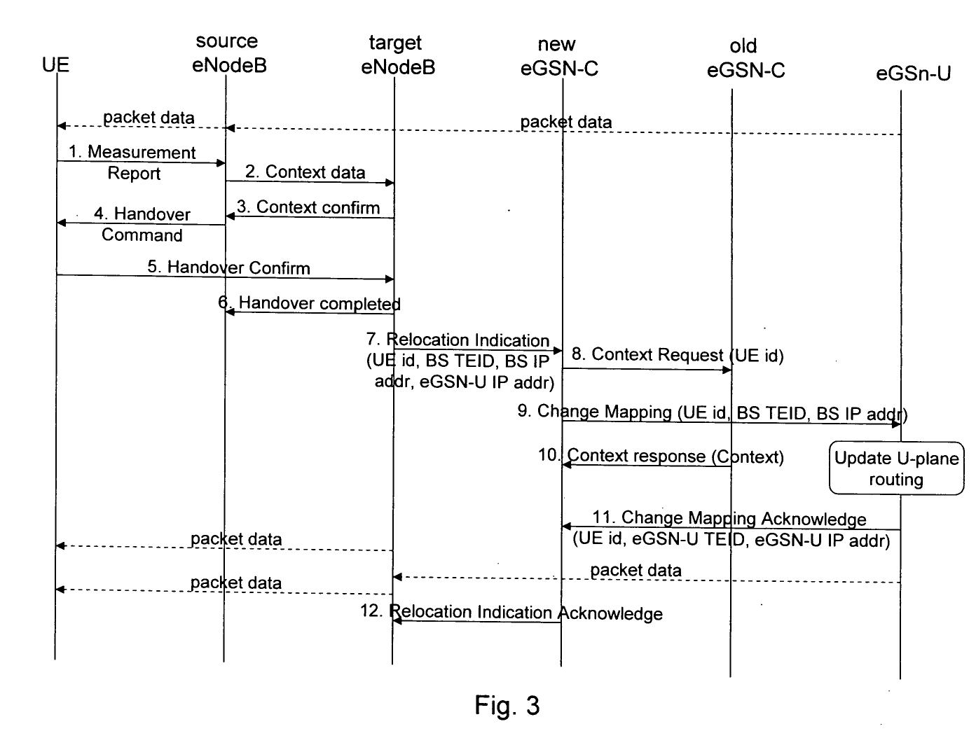

FIG. 3 shows a signaling diagram of a method according to a third embodiment of the present invention. In detail, there is illustrated an inter-MME handover procedure, wherein the core network is not involved in handover preparation, wherein late switching and base station forwarding is used, and wherein path switching is effected from the target base station entity via the target control plane entity to the user plane entity.

The third embodiment may thus be regarded as an alternative to the second embodiment described above.

As well as in FIGS. 1 and 2, steps 1 to 6 of FIG. 3 represent an access network handover between a source base station or eNodeB and a target base station or eNodeB, the description of which will be omitted herein.

The completion of the access network handover, the decision on the need of a core network handover, the selection of a target control plane entity and the initiation of the core network handover by the target base station is similar to those as described in connection with the embodiments of FIGS. 1 and 2.

The core network handover according to the present embodiment is based on a path switching from the target base station entity via the target control plane entity to the user plane entity, and is performed as follows.

In step 7 of FIG. 3, a relocation indication message from the target eNodeB to the new eGSN-C additionally includes as a further parameter the address of the user plane entity “eGSN-U control addr”. Thus, the target eNodeB must have received it from the source eNodeB beforehand, e.g. in step 2 above.

Hence, in the embodiment of FIG. 3, the new eGSN-C does not have to firstly fetch the user context data (including e.g. eGSN-U control IP address) from the old eGSN-C in order to be able to contact the eGSN-U. Rather, the new eGSN-C can send messages at the same time to both the old eGSN-C and the eGSN-U. This makes the user plane switching a bit faster.

Namely, according to the present embodiment, the context request (step 8) to the old eGSN-C and the change mapping message (step 9) to the eGSN-U can be sent practically simultaneously. Accordingly, the order of the individual messages according to the third embodiment differs from that according to the second embodiment, the messages as such however being the same in both embodiments.

Although no change of the user plane entity during the MME handover has been shown above, it is also covered by the present invention that the user plane entity as well may be changed.

Hereinbefore the present invention is described with regard to embodiments directed to methods thereof. However, the present invention also covers respective network nodes, operating methods for these network nodes as well as computer programs.

That is, the present invention also covers a base station entity being configured to operate as a target eNodeB as described above, a control plane entity being configured to operate as a new (target) eGSN-C as described above, and a control plane entity being configured to operate as an old (source) eGSN-C as described above.

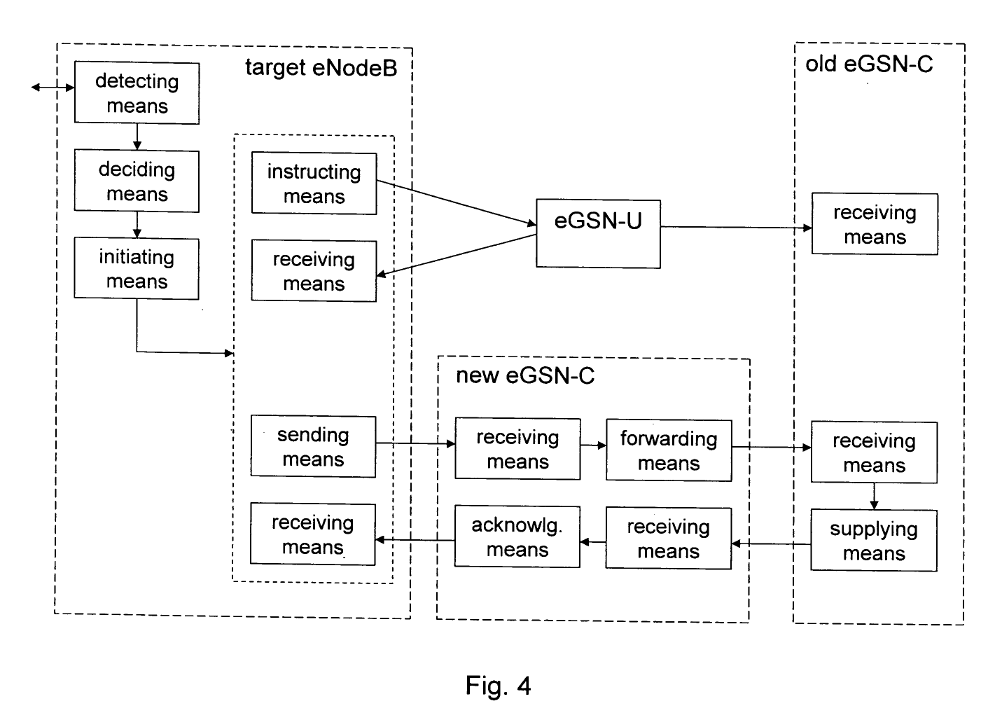

In the following, embodiments of these network nodes will be described by way of example only with reference to FIGS. 4 to 6. It is to be noted that any suitable combination of the network nodes and/or elements thereof is intended to be covered by the present invention, e.g. as is set out in the following.

FIG. 4 shows a schematic block diagram of a system according to a fourth embodiment of the present invention. The thus illustrated system exemplarily comprises a base station entity acting as a target eNodeB, a control plane entity acting as a target eGSN-C and a control plane entity acting as a source eGSN-C. The system and network nodes of the present embodiment are adapted to perform the method steps as described above in connection with the embodiment of FIG. 1.

The arrows between the individual network nodes and/or element thereof schematically illustrate both the interconnection thereof and the flow of operation.

The target eNodeB of FIG. 4 comprises a detecting means for detecting a completion of a radio network handover with respect to a user equipment and a source eNodeB (the connection to which being indicated by a double-headed arrow. The target eNodeB further comprises initiating means for initiating, upon detection of a radio network handover completion, a core network handover. Between the detecting means and the initiating means there is optionally provided a deciding means for taking a respective decision on a core network handover.

The initiating means initiates the core network handover by triggering a handover section being indicated by a dashed block. The handover section encompasses instructing means and receiving means for cooperating with the user plane entity UPE according to steps 7 and 10 of FIG. 1 as well as sending means and receiving means for cooperating with the target eGSN-C according to steps 8 and 13 of FIG. 1.

The target eGSN-C of FIG. 4 comprises receiving means and forwarding means adapted to perform the steps 8 and 9 of FIG. 1. Further, the target eGSN-C comprises receiving means and acknowledging means adapted to perform the steps 12 and 13 of FIG. 1.

The source eGSN-C of FIG. 4 comprises receiving means adapted to perform the step 11 of FIG. 1, and further comprises receiving means and supplying means adapted to perform the steps 9 and 12 of FIG. 1.

The operation of any individual element of FIG. 4 will be apparent to a skilled person when referring to the detailed description of the method according to FIG. 1.

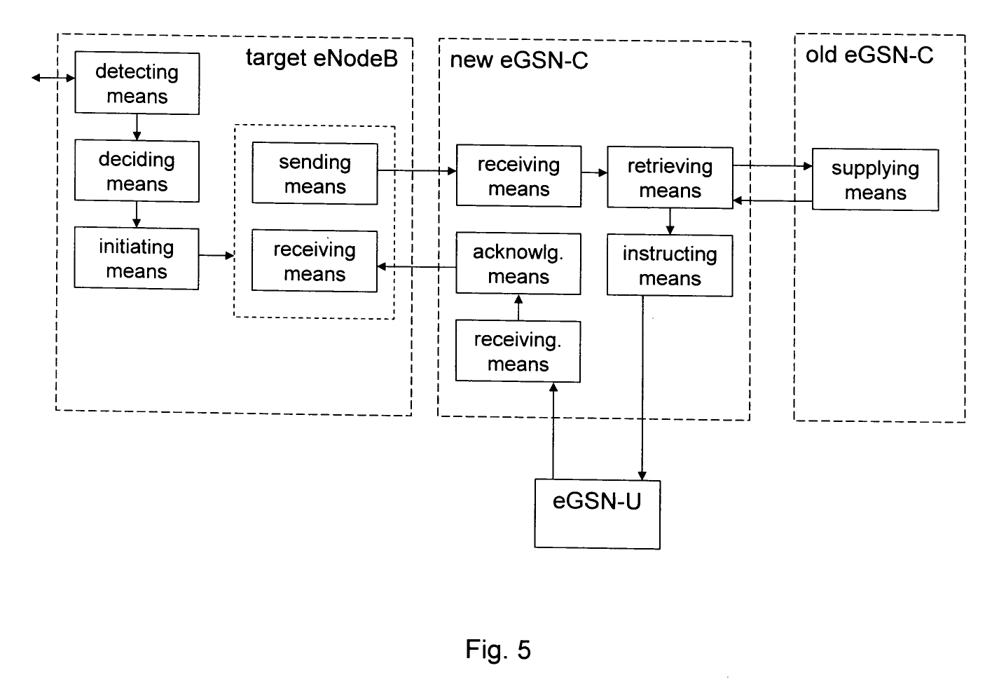

FIG. 5 shows a schematic block diagram of a system according to a fifth embodiment of the present invention. The thus illustrated system exemplarily comprises a base station entity acting as a target eNodeB, a control plane entity acting as a target eGSN-C and a control plane entity acting as a source eGSN-C. The system and network nodes of the present embodiment are adapted to perform the method steps as described above in connection with the embodiment of FIG. 2.

The arrows between the individual network nodes and/or element thereof schematically illustrate both the interconnection thereof and the flow of operation.

The target eNodeB of FIG. 5 comprises detecting means, deciding means and initiating means in accordance with those of the embodiment of FIG. 4 above, reference to which is made for details.

The initiating means again initiates the core network handover by triggering a handover section being indicated by a dashed block. The handover section encompasses sending means and receiving means for cooperating with the target eGSN-C according to steps 7 and 12 of FIG. 2.

The target eGSN-C of FIG. 5 comprises receiving means and retrieving means adapted to perform the steps 7, 8 and 9 of FIG. 2. Further, the target eGSN-C comprises instructing means, receiving means and acknowledging means adapted to perform the steps 10, 11 and 12 of FIG. 2.

The source eGSN-C of FIG. 5 comprises supplying means adapted to perform the steps 8 and 9 of FIG. 2.

The operation of any individual element of FIG. 5 will be apparent to a skilled person when referring to the detailed description of the method according to FIG. 2.

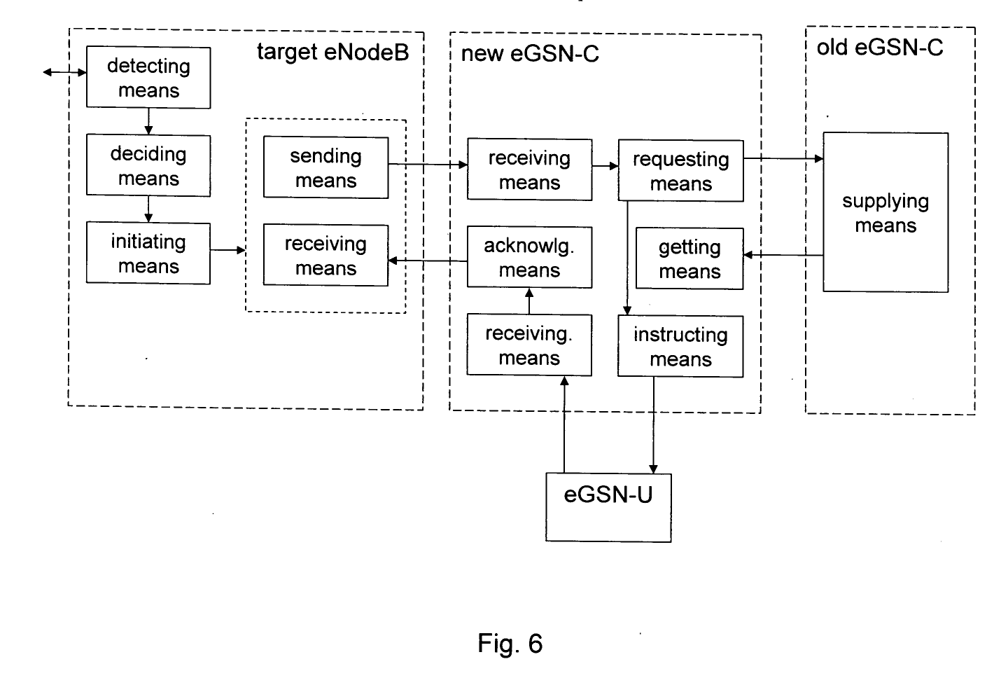

FIG. 6 shows a schematic block diagram of a system according to a sixth embodiment of the present invention. The thus illustrated system exemplarily comprises a base station entity acting as a target eNodeB, a control plane entity acting as a target eGSN-C and a control plane entity acting as a source eGSN-C. The system and network nodes of the present embodiment are adapted to perform the method steps as described above in connection with the embodiment of FIG. 3.

The arrows between the individual network nodes and/or element thereof schematically illustrate both the interconnection thereof and the flow of operation.

The target eNodeB of FIG. 6 comprises detecting means, deciding means and initiating means in accordance with those of the embodiment of FIG. 4 above, reference to which is made for details.

The initiating means again initiates the core network handover by triggering a handover section being indicated by a dashed block. The handover section encompasses sending means and receiving means for cooperating with the target eGSN-C according to steps 7 and 12 of FIG. 3. For example, the difference between the instructing means of FIG. 6 as compared to the instructing means of FIG. 5 is that it is adapted to further include the address of the user plane entity “eGSN-U control addr” into the relocation indication message being sent to the target control plane entity.

The target eGSN-C of FIG. 6 comprises receiving means and requiring means adapted to perform the steps 7 and 8 of FIG. 3. Further, the target eGSN-C comprises instructing means, receiving means and acknowledging means adapted to perform the steps 9, 11 and 12 of FIG. 3. In addition, it comprises getting means for getting user context data from the old (source) eGSN-C, i.e. to perform the step 10 of FIG. 3. After having gotten the user context data, the getting means of this embodiment (as well as the respective receiving means of the embodiment of FIG. 4 and the retrieving means of the embodiment of FIG. 5) processed the context data accordingly. For example, the context data are stored and, if need be, used for communication purposes for the user equipment associated with these user context data.

The source eGSN-C of FIG. 6 comprises supplying means adapted to perform the steps 8 and 9 of FIG. 3.

The operation of any individual element of FIG. 6 will be apparent to a skilled person when referring to the detailed description of the method according to FIG. 3.

In general, it is also to be noted that the mentioned functional elements, e.g. requesting means or instructing means according to the present invention can be implemented by any known means, either in integrated or removable hardware and/or software, respectively, if it is only adapted to perform the described functions of the respective parts. For example, the instructing means of the above embodiments can be implemented by any data processing unit, e.g. a microprocessor, being configured to send an accordingly configured change mapping instruction message to the respective network node as defined above and below. The mentioned parts can also be realized in individual functional blocks or by individual devices, or one or more of the mentioned parts can be realized in a single functional block or by a single device. Correspondingly, the above illustration of FIGS. 4 to 6 is only for illustrative purposes and does not restrict an implementation of the present invention in any way.

Furthermore, method steps likely to be implemented as software code portions and being run using a processor at one of the entities are software code independent and can be specified using any known or future developed programming language such as e.g. Java, C, C++, and Assembler. Method steps and/or devices or means likely to be implemented as hardware components at one of the peer entities are hardware independent and can be implemented using any known or future developed hardware technology or any hybrids of these, such as MOS, CMOS, BICMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

In summary, the present invention and embodiments thereof provide an inter-MME handover (i.e. control plane change) in active mode:

independently of an UPE handover (i.e. user plane change);

when MME and UPE, and thus control plane and user plane, are separate; and

when the core network is not involved in handover preparation (rather, the core network only knows about the handover once the handover is already completed from radio point of view).

According to embodiments of the present invention, to enable a handover from an old MME to a new MME, it is ensured that:

the new control node is informed that the control is going to be moved to the concerned node;

the old control node is identified to the new control node, so that the new control node can fetch the user information from the old control node; and

the old control node is informed that the control is switched to the new node.

According the present invention, there are provided measures for a handover in a communication system, the communication system comprising an access network having at least two base station entities and a core network having at least two control plane entities and a user plane entity, comprising the steps of initiating, upon completion of a radio network handover between a source base station entity and a target base station entity, a core network handover by the target base station entity, and performing the core network handover between a source control plane entity and a target control plane entity, wherein the user plane entity is maintained the same or changed.

Even though the invention is described above with reference to the examples according to the accompanying drawings, it is clear that the invention is not restricted thereto. Rather, it is apparent to those skilled in the art that the present invention can be modified in many ways without departing from the scope of the inventive idea as disclosed above or in the attached claims.

We claim:

1. A method of handover in a communication system, the method comprising
initiating, upon completion of a radio network handover between a source base station entity and a target base station entity, a core network handover by the target base station entity; and
performing the core network handover between a source control plane entity and a target control plane entity, wherein the user plane entity is maintained the same or changed,
the communication system comprising an access network having at least two base station entities and a core network having at least two control plane entities and at least one user plane entity.

2. The method of claim 1, further comprising:
deciding to change the user plane entity, if the target base station entity is not able to serve the user plane entity after the radio network handover.

3. The method of claim 1, wherein the performing the core network handover is based on a direct path switching from the target base station entity to the user plane entity.

4. The method of claim 1, wherein the performing the core network handover further comprises:
instructing a user plane mapping change from the target base station entity to the user plane entity;
changing user plane mapping, at the user plane entity, between the source base station entity and the target base station entity;
acknowledging user plane mapping change from the user plane entity to the target base station entity; and
notifying, by the user plane entity, the source control plane entity of a user plane mapping change.

5. The method of claim 1, wherein the performing the core network handover further comprises:
sending a relocation indication from the target base station entity to the target control plane entity;
forwarding the relocation indication from the target control plane entity to the source control plane entity;
supplying, upon notification of a user plane mapping change, user context data from the source control plane entity to the target control plane entity; and
acknowledging a relocation from the target control plane entity to the target base station entity.

6. The method of claim 1, wherein the performing the core network handover is based on a path switching from the target base station entity via the target control plane entity to the user plane entity.

7. The method of claim 1, wherein the performing the core network handover further comprises:
sending a relocation indication from the target base station entity to the target control plane entity;
supplying user context data from the source control plane entity to the target control plane entity;
instructing, upon supply of the user context data, a user plane mapping change from the target control plane entity to the user plane entity;
changing user plane mapping, at the user plane entity, between the source base station entity and the target base station entity;
acknowledging the user plane mapping change from the user plane entity to the target control plane entity; and
acknowledging the relocation indication from the target control plane entity to the target base station entity.

8. The method of claim 1, wherein the performing the core network handover further comprises:
sending a relocation indication from the target base station entity to the target control plane entity, the relocation indication including a user plane entity address;
requesting, by the target control plane entity, user context data from the source control plane entity;
instructing a user plane mapping change from the target control plane entity to the user plane entity by use of the user plane entity address;
changing user plane mapping, at the user plane entity, between the source base station entity and the target base station entity;
supplying user context data from the source control plane entity to the target control plane entity;
acknowledging the user plane mapping change from the user plane entity to the target control plane entity; and
acknowledging the relocation indication from the target control plane entity to the target base station entity.

9. A method comprising:
operating a control plane entity of a communication system, the communication system comprising an access network having at least two base station entities and a core network having at least two control plane entities and at least one user plane entity, the control plane entity acting as a target control plane entity of a core network handover; and
performing the core network handover between a source control plane entity and the target control plane entity, wherein the user plane entity is maintained the same or changed.

10. The method of claim 9, wherein the performing the core network handover further comprises:
receiving a relocation indication from a target base station entity of a completed access network handover;
forwarding the relocation indication to a source control plane entity of the core network handover;
receiving user context data from the source control plane entity; and
acknowledging a relocation to the target base station entity.

11. The method of claim 9, wherein the performing the core network handover further comprises:
receiving a relocation indication from a target base station entity of a completed access network handover;
retrieving user context data from the source control plane entity;
instructing, upon supply of the user context data, a user plane mapping change to the user plane entity;
receiving an acknowledgement of the instruction of a user plane change; and
acknowledging the relocation indication to the target base station entity.

12. A base station entity of a communication system, the base station entity comprising:
a detecting unit configured to detect a completion of a radio network handover between a source base station entity and said base station entity acting as a target base station entity; and
an initiating unit configured to initiate, upon detection of a radio network handover completion, a core network handover,
the communication system comprising an access network having at least two base station entities and a core network having at least two control plane entities and at least one user plane entity.

13. The base station entity of claim 12, further comprising:
a deciding unit configured to decide to change the user plane entity, if the target base station entity is not able to serve the user plane entity after the radio network handover.

14. The base station entity of claim 12, further comprising:
an instructing unit configured to instruct a user plane mapping change from the target base station entity to the user plane entity; and
a receiving unit configured to receive an acknowledgement of the user plane mapping change from the user plane entity.

15. The base station of claim 12, further comprising:
a sending unit configured to send a relocation indication from the target base station entity to the target control plane entity; and
a receiving unit configured to receive an acknowledgement of a relocation from the target control plane entity.

16. A base station entity of a communication system, the base station entity comprising:
detecting means for detecting a completion of a radio network handover between a source base station entity and said base station entity acting as a target base station entity; and
initiating means for initiating, upon detection of a radio network handover completion, a core network handover,
the communication system comprising an access network having at least two base station entities and a core network having at least two control plane entities and at least one user plane entity.

17. A control plane entity of a communication system, wherein the control plane entity is configured to perform a core network handover between said control plane entity and another control plane entity, wherein the user plane entity is maintained the same or changed and wherein the communication system comprises an access network having at least two base station entities and a core network having at least two control plane entities and at least one user plane entity.

18. The control plane entity of claim 17, wherein the control plane entity is configured to act as a target control plane entity of the core network handover.

19. The control plane entity of claim 17, comprising:
a receiving unit configured to receive a relocation indication from a target base station entity of a completed access network handover;
a forwarding unit configured to forward the relocation indication to a source control plane entity of the core network handover;
a second receiving unit configured to receive user context data from the source control plane entity; and
an acknowledging unit configured to acknowledge a relocation to the target base station entity.

20. A system in a communication network, the system comprising:
at least one base station entity configured to act as a target base station entity of an access network handover; and
at least two control plane entities, one of the at least two control plane entities being configured to act as a source control plane entity of a control network handover and another one of the at least two control plane entities being configured to act as a target control plane entity of the control network handover,
wherein the communication network comprises an access network having at least two base station entities and a core network having at least two control plane entities and at least one user plane entity.

21. The system of claim 20, wherein the at least one base station entity is configured to detect a completion of a radio network handover between a source base station entity and said base station entity acting as a target base station entity, and to initiate, upon detection of a radio network handover completion, a core network handover.

22. The system of claim 20, wherein the control plane entity acting as the target entity is configured to perform a core network handover between said control plane entity and another control plane entity, wherein the user plane entity is maintained the same or changed.

23. The system of claim 20, wherein the control plane entity acting as the source entity is configured to perform a core network handover between said control plane entity and another control plane entity, wherein the user plane entity is maintained the same or changed.

24. A computer program, embodied in a computer-readable medium, comprising program code configured to operate a base station entity of a communication system, the computer program being configured to:
detect a completion of a radio network handover between a source base station entity and said base station entity acting as a target base station entity; and
initiate, upon detection of a radio network handover completion, a core network handover between a source control plane entity and a target control plane entity,
the communication system comprising an access network having at least two base station entities and a core network having at least two control plane entities and at least one user plane entity

25. A computer program, embodied in a computer-readable medium, comprising program code configured to operate a control plane entity of a communication system, the computer program being configured to perform the core network handover between a source control plane entity and the target control plane entity, wherein the user plane entity is maintained the same or changed,
the communication system comprising an access network having at least two base station entities and a core network having at least two control plane entities and at least one user plane entity, the control plane entity acting as a target control plane entity of a core network handover.

26. A computer program, embodied in a computer-readable medium, comprising program code configured to operate a control plane entity of a communication system, the computer program being configured to perform
the core network handover between the source control plane entity and a target control plane entity, wherein the user plane entity is maintained the same or changed,
the communication system comprising an access network having at least two base station entities and a core network having at least two control plane entities and at least one user plane entity, the control plane entity acting as a source control plane entity of a core network handover.
